(19) United States
(12) Patent Application Publication
(10) Pub. No.: US 2013/0293178 A1
(43) Pub. Date: Nov. 7, 2013

(54) MOTOR CONTROL PROFILER

(71) Applicants: Se Jin Kang, Seoul (KR); Kwan Ok Kim, Seoul (KR)

(72) Inventors: Se Jin Kang, Seoul (KR); Kwan Ok Kim, Seoul (KR)

(21) Appl. No.: 13/479,564

(22) Filed: May 24, 2012

(30) Foreign Application Priority Data
May 4, 2012 (KR) 10-2012-0035686

(51) Int. Cl. G05B 17/02

(52) U.S. Cl. 318/600

(57) ABSTRACT

A motor control profiler includes: a position calculation main state machine for generating command data to control a motor, the command data being in a polynomial expression of higher degree; a parameter set machine for setting a coefficient and a constant of the polynomial expression of higher degree of the command data; a control state machine for setting a control state of the motor; a time slot control and computation resource management machine for controlling a calculation machine, based on the set coefficient and constant of the polynomial expression of higher degree and the set control state of the motor; and a calculation machine for calculating the amount of motion according to the drive of the motor based on the time slot control and computation resource management.

### CROSS-REFERENCE TO RELATED APPLICATION

This application claims the benefit of Korean Patent Application No. 2012-0035686, filed Apr. 5, 2012, the disclosure of which is hereby incorporated herein by reference in its entirety.

### BACKGROUND OF THE INVENTION

1. Field of the Invention

The present invention relates to a motor control profiler in the constitution where parameters and control states of command data are easily changed to optimally control a power source and a motor of an electronic system in various forms.

2. Description of the Related Art

A motor control profiler is to be realized to prevent any errors in software development and to reduce development costs by simulating the performance of an electronic system to be developed and simulating software in many different run modes to find a point where a bottleneck occurs. To realize such a motor control profiler, there is used a method of controlling parameters (such as acceleration, constant velocity, deceleration, completion, etc.) in a polynomial expression of a motor control profiler in relation to a CPU program or application-specific hardware of an electronic system.

However, the aforementioned profiler cannot randomly change a part or the whole of the polynomial expression or parameters of the profiler whenever the specifications of the CPU program or application-specific hardware of an electronic system change, and because of this the aforementioned profiler is deficient.

### SUMMARY OF THE INVENTION

Therefore, it is an object of the present invention to provide a motor control profiler which is easily modified and supplemented by setting parameters and control states of command data to drive a CPU program or application-specific hardware of an electronic system, thereby precisely and stably controlling a motor of the electronic system without developing any new profiler.

In accordance with an embodiment of the present invention, there is provided a motor control profiler comprising: a position calculation main state machine for generating command data to control a motor, the command data being in a polynomial expression of higher degree; a parameter set machine for setting a coefficient and a constant of the polynomial expression of higher degree of the command data; a control state machine for setting a control state of the motor; a time slot control and computation resource management machine for controlling a calculation machine, based on the set coefficient and constant of the polynomial expression of higher degree and the set control state of the motor; and a calculation machine for calculating the amount of motion according to the drive of the motor, based on the time slot control and computation resource management machine.

In accordance with another embodiment of the present invention, there is provided a method of operating a motor control profiler comprising the steps of: generating command data to control a motor, the command data being in a polynomial expression of higher degree; setting a parameter of the generated polynomial expression of higher degree and a control state of the motor; counting the number of an acceleration section(s), the number of a constant velocity section(s) and the number of a deceleration section(s), based on the set parameter of the polynomial expression of higher degree and the set control state of the motor; controlling an acceleration equation, a constant velocity equation, a deceleration equation and a completion equation, based on the set control state of the motor; and calculating a moving distance by each of the acceleration section, the constant velocity section and the deceleration section, based on the counted number of the acceleration section(s), the counted number of the velocity section(s) and the counted number of the deceleration section(s).

### BRIEF DESCRIPTION OF THE DRAWINGS

The above and other features and advantages of the present invention will become more apparent to those of ordinary skill in the art by describing in detail a preferred embodiment thereof with reference to the attached drawings in which:

FIG. 1 is a schematic block diagram of the constitution of a motor control profiler according to the present invention.

### DETAILED DESCRIPTION OF THE PREFERRED EMBODIMENT

The present invention will now be described more fully hereinafter with reference to the accompanying drawing(s), in which a preferred embodiment of the invention is shown so that those of ordinary skill in the art can easily carry out the present invention.

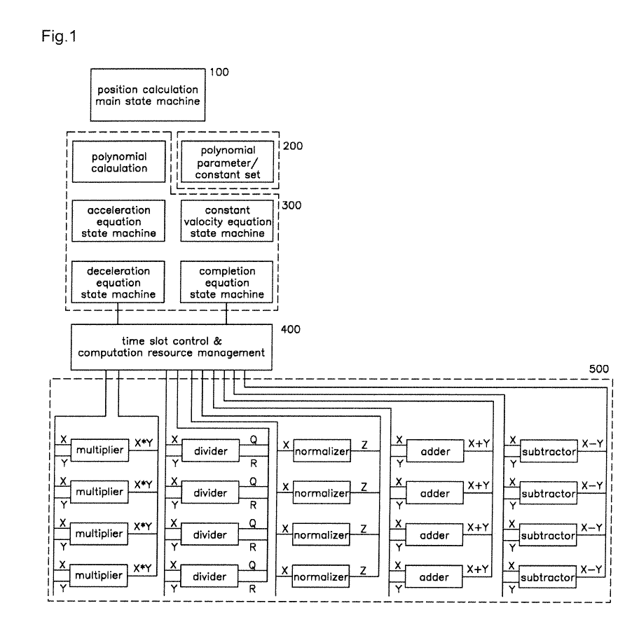

FIG. 1 schematically shows the constitution of a motor control profiler according to the present invention.

The motor control profiler comprises: a position calculation main state machine 100, a parameter set machine 200, a control state machine 300, a time slot control and computation resource management machine 400 and a calculation machine 500.

The position calculation main state machine 100 generates command data in a polynomial expression of higher degree, to control the velocity of a motor.

The parameter set machine 200 sets a coefficient value and a constant value of the polynomial expression of higher degree of the command data to drive the motor. When the constitution of a CPU program or hardware of an electronic system is changed, the parameter set machine 200 changes the parameters, such as the coefficient value and the constant value of the polynomial expression of higher degree, to constitute the most suitable profiler for the newly changed electronic system.

The control state machine 300 defines an acceleration state, a deceleration state, a constant velocity state and a completion state by setting an acceleration equation, a deceleration equation, a constant velocity equation and a completion equation of the motor control profiler. When the constitution of a CPU program or hardware of the electronic system is changed, the control state machine 300 changes the control state of the polynomial expression of higher degree, to constitute the most suitable profiler for the newly changed electronic system.

The time slot control and computation resource management machine 400 controls the number of an acceleration section(s), the number of a constant velocity section(s) and the number of a deceleration section(s) per motor driving pulse period, based on the set coefficient and constant of the polynomial expression of higher degree. The time slot control and computation resource management machine 400 also controls the acceleration equation, the constant velocity equation, the deceleration equation and the completion equation, based on the control states of the motor, that is, the acceleration state, the deceleration state, etc.

The calculation machine 500 comprises a plurality of adders 510, a plurality of subtractors 520, a plurality of multipliers 530, a plurality of dividers 540 and a plurality of normalizers 550. The calculation machine 500 calculates the amount of motion in each of the acceleration section, the constant velocity section and the deceleration section according to the drive of the motor, based on the slot control and computation resource management machine 400. That is, the calculation machine 500 calculates the amount of motion in the acceleration section by multiplying the velocity extracted from the command data in the polynomial expression of higher degree by a motor driving pulse period and the number of the acceleration section(s). The calculation machine 500 calculates the amount of motion in the constant velocity section by multiplying the velocity extracted from the command data in the polynomial expression of higher degree by a motor driving pulse period and the number of the constant velocity section(s). The calculation machine 500 calculates the amount of motion in the deceleration section by multiplying the velocity extracted from the command data in the polynomial expression of higher degree by a motor driving pulse period and the number of the deceleration section(s).

The calculation results by the adders 510, subtractors 520, multipliers 530, dividers 540 and normalizers 550 of the calculation machine 500 are processed in a parallel pipeline. That is, a plurality of the calculating units, such as the adders 510, subtractors 520, multipliers 530, dividers 540 and normalizers 550, are installed to sequentially execute the calculation, to make it possible to fast determine whether the set coefficient of the polynomial expression of higher degree and the set control state are suitable and therefore to make it possible to develop a stable profiler in a short period of time.

In accordance with the motor control profiler of the present invention, the parameters of command data to drive a CPU program or application-specific hardware of an electronic system and the control sates of a motor are set, thereby making it easy to modify and supplement the profiler and therefore making it possible to precisely and stably control the motor of the electronic system without developing any new profiler.

In accordance with the method of operating the motor control profiler according to the present invention, it is easy to realize the profiler in various forms and it is possible to develop a stabilized profiler in a short period of time, thereby being easily applied in electronic systems in many different forms.

The invention has been described using a preferred exemplary embodiment. However, it is to be understood that the scope of the invention is not limited to the disclosed embodiment. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A motor control profiler comprising:
a position calculation main state machine for generating command data to control a motor, the command data being in a polynomial expression of higher degree;
a parameter set machine for setting a coefficient and a constant of the polynomial expression of higher degree of the command data;
a control state machine for setting a control state of the motor;
a time slot control and computation resource management machine for controlling a calculation machine, based on the set coefficient and constant of the polynomial expression of higher degree and the set control state of the motor; and
a calculation machine for calculating the amount of motion according to the drive of the motor based on the time slot control and computation resource management.

2. The motor control profiler of claim 1, wherein the control state of the motor includes an acceleration state, a deceleration state, a constant velocity state and a completion state of the motor.

3. The motor control profiler of claim 1, wherein the calculation machine comprises an adder, a subtractor, a multiplier, a divider and a normalizer.

4. The motor control profiler of claim 3, wherein a calculation result by the calculation machine is processed by a pipeline.

5. A method of operating a motor control profiler comprising the steps of:
generating command data to control a motor, the command data being in a polynomial expression of higher degree;
setting a parameter of the generated polynomial expression of higher degree and a control state of the motor;
counting the number of an acceleration section(s), the number of a constant velocity section(s) and the number of a deceleration section(s), based on the set parameter of the polynomial expression of higher degree and the set control state of the motor;
controlling an acceleration equation, a constant velocity equation, a deceleration equation and a completion equation, based on the set control state of the motor; and
calculating a moving distance by each of the acceleration section, the constant velocity section and the deceleration section, based on the counted number of the acceleration section(s), the counted number of the velocity section(s) and the counted number of the deceleration section(s).

6. The method of claim 5, wherein the control state of the motor includes an acceleration state, a deceleration state, a constant velocity state and a completion state of the motor.
